(19) United States
(12) Patent Application Publication
(10) Pub. No.: US 2009/0113374 A1
(43) Pub. Date: Apr. 30, 2009

(54) Method for designing semiconductor device layout and layout design supporting apparatus

(75) Inventor: Naoko Nakagawa, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/289,198

(22) Filed: Oct. 22, 2008

(30) Foreign Application Priority Data
Oct. 30, 2007 (JP) 2007-281304

(51) Int. Cl. G06F 17/50

(52) U.S. Cl. 716/14

(57) ABSTRACT

In a layout design method for a semiconductor device having a hard macro, a netlist data of the semiconductor device and a hard macro data are read out from a storage section. An arrangement position of the hard macro is determined from the netlist data and the hard macro data, and an extension direction of an interconnection pattern in a specified area of a chip for the semiconductor device is determined based on arrangement restriction data. The interconnection pattern is arranged to extend in the determined extension direction in the specified area.

### INCORPORATION BY REFERENCE

This application claims priority on convention based on Japanese Patent Application No. 2007-281304. The disclosure thereof is incorporated herein by reference.

### BACKGROUND OF THE INVENTION

1. Field of the Invention

The present invention relates to a method for designing a layout of a semiconductor device and a layout design supporting apparatus. More particularly, the present invention is directed to a technique for layout of a semiconductor device with a multilayer interconnection structure.

2. Description of Related Art

In the design of a large-scale circuit, a method is used in which the circuit is divided into several blocks and a designing and a confirming operation are performed in units of functions for every block (i.e. hierarchical design). This block is called a macro, and the macro includes a soft macro and a hard macro.

The soft macro consists only of connection data between elements (i.e. netlist) without including layout data on a chip. That is, arrangement and interconnection of patterns on the chip can be flexibly performed with easy customization according to a using condition. However, the soft macro does not include arrangement data, so that performance of the macro needs to be confirmed after the layout is completed.

The hard macro includes layout data on a chip in addition to connection data between elements (i.e. netlists). Since the layout of hard macros is completed prior to the layout on the chip, specification can be guaranteed before the chip layout. Each of the hard macros is also optimized. Therefore, the hard macro has a superior characteristic in comparison with the soft macro when an equivalent function is configured. However, the hard macro has a fixed shape, which results in low degrees of freedom in the layout on the chip. When the chip has a multilayer interconnection structure of a first to an N^{th} layers, arrangement of an interconnection pattern in the N^{th} interconnection layer is inhibited, if the hard macro uses the N interconnection layers for the layout design. There is a case that it is further inhibited to arrange an interconnection pattern in the interconnection layer above the hard macro. Thus, an interconnection pattern in an intra-chip interconnection layer is prevented from influencing on an interconnection pattern in the intra-macro interconnection layer.

In a layout design of the semiconductor device, the arrangement of an interconnection pattern in the intra-chip interconnection layer is determined based on a layer data indicating one of the interconnection layers above the hard macro in which the arrangement of an interconnection pattern is inhibited, and a data indicating an inhibited area in the hard macro. In this case, parallel arrangement and orthogonal arrangement of the interconnection pattern in a specified area in the interconnection layer are inhibited based on the layer data and the inhibited area data. In this case, arrangement of an intra-chip interconnection pattern is determined to make a detour to avoid the inhibited area. In order to reduce cost in manufacturing a semiconductor device, it is required to reduce an arrangement dedicated area for the interconnection pattern as much as possible by efficiently arranging hard macros on the chip. For this purpose, it is absolutely essential to reduce the size of the chip as much as possible. A technique for interconnection design in the hierarchical design layout using hard macros is known in the following related arts 1 to 5.

FIG. 1 is a plan view showing a planar structure of a semiconductor device disclosed in Japanese Patent Application Publication (JP-A-Heisei 10-270561: the related art 1). In this related art, a chip 111 has an interconnection structure from a first layer to an N^{th} layer (N is an integer larger than 1), and a block 114 has the interconnection layers to (N-1)^{th} interconnection layer used and is arranged in a free area in the periphery of blocks 112. An interconnection pattern 113 between macros 112b and 112c is not required to make a detour to avoid the block 114. Thus, the interconnection length can be shortened and area reduction in one chip is possible.

In the design of this chip 111, a floor plan is estimated on the assumption that the hard macros 112, 112b and 112c use the interconnection layers to the N^{th} layer. Thereafter, a hard macro is found which is arranged in a peripheral free area and is restructured to a hard macro 114 in which the interconnection layers to the (N-1)^{th} layer are used.

FIG. 2 is a plan view showing a planar structure of a semiconductor device disclosed in Japanese Patent Application Publication (JP-P2002-368106A: the related art 2). In the related art 2, a method is proposed of designing a multilayer interconnection structure in a hard macro, in which an interconnection pattern within a hard macro is recognized and the orientation of the hard macro is determined. In a semiconductor device 201, it is assumed that three hard macros 202a, 202b and 202c are arranged. An interconnection area 205 is also provided in the periphery of the hard macros. The semiconductor device 201 further has electrode pads 204a and 204b arranged in the periphery thereof, to input/output signals from/to an outside of a chip. The electrode pad 204a is connected to the hard macro 202a and the electrode pad 204b is connected to the hard macro 202b. The hard macro 202c has a plurality of memory cells arranged therein.

FIG. 3 is an expanded view of a part of the plan view of FIG. 2. In the hard macro 202c, bit line patterns 206a and 206b and word line patterns 207 are provided. The word line patterns 207 are arranged to be orthogonal to the bit line patters 206a and 206b. A signal interconnection pattern 203a (or 203b) is also arranged in parallel to the word line patterns 207. In the method of designing a layout for the semiconductor device 201, the bit line patterns 206a and 206b in the hard macro 202c are recognized, and a method of the arrangement of the signal line patterns 203a and 203b above the hard macro 202c is determined on the basis of the recognized bit line patterns. Then, the signal line patterns are arranged above the hard macro 202c on the basis of the determined method. At this time, the extending direction and area of the signal line patterns 203a and 203b are determined in such a manner that the signal line patterns are orthogonal to the bit line patterns 206a and 260b. In this way, overlapping portions 223a and 223b of the signal line pattern 203a or 203b and the bit line patterns 206a and 206b can be reduced, so that influence to the bit line patterns can be reduced.

Japanese Patent Application Publication (JP-P2001-230327A: the related art 3) discloses a semiconductor device in which an intra-block line pattern in a block is orthogonal to an inter-block line pattern. Japanese Patent Application Publication (JP-A-Heisei 5-151313: the related art 4) further discloses a semiconductor device in which an inter-cell line pattern extends in a vertical direction and an intra-chip line pattern is arranged in a horizontal direction. Moreover, Japanese Patent Application Publication (JP-A-Heisei 10-214903: the related art 5) discloses a semiconductor device in which a gate polysilicon line pattern is arranged in a longitudinal direction and a line pattern is arranged in a lateral direction.

In the above-mentioned related art 1, each of the hard macros has the interconnection structure of (N-1) layers and the hard macros are connected by using the N^{th} interconnection layer. In this case, the influence of the interconnection pattern in the N^{th} interconnection layer to the interconnection pattern in the (N-1)^{th} interconnection layer is not considered. When the interconnection pattern in the N^{th} interconnection layer are arranged in parallel to the interconnection pattern in the (N-1)^{th} interconnection layer with a minimum distance, a coupling capacitance between the patterns is increased. As a result, when crosstalk is caused, a signal change is caused in the interconnection pattern via the coupling capacitance.

According to the related art 2, a significantly long process time is required if the number of signal line patterns in the hard macro increases.

### SUMMARY

In an aspect of the present invention, a layout design method for a semiconductor device having a hard macro, includes: reading out a netlist data of the semiconductor device and a hard macro data from a storage section; determining an arrangement position of the hard macro from the netlist data and the hard macro data; determining an extension direction of an interconnection pattern in a specified area of a chip for the semiconductor device based on arrangement restriction data; and arranging the interconnection pattern to extend in the determined extension direction in the specified area.

In another aspect of the present invention, a layout design supporting apparatus for a semiconductor device having a hard macro, includes: a storage section configured to store a netlist data of the semiconductor device and a hard macro data; and a processing section configured to read out the netlist data of the semiconductor device and the hard macro data from the storage section, to determine an arrangement position of the hard macro from the netlist data and the hard macro data, to determining an extension direction of an interconnection pattern in a specified area of a chip for the semiconductor device based on arrangement restriction data, and to arrange the interconnection pattern to extend in the determined extension direction in the specified area.

In still another aspect of the present invention, a computer-readable recording medium in which code of a computer-readable program is recorded for a layout design method for a semiconductor device having a hard macro, the layout design method comprises: reading out a netlist data of the semiconductor device and a hard macro data from a storage section; determining an arrangement position of the hard macro from the netlist data and the hard macro data; determining an extension direction of an interconnection pattern in a specified area of a chip for the semiconductor device based on arrangement restriction data; and arranging the interconnection pattern to extend in the determined extension direction in the specified area.

According to the present invention, it is possible to efficiently use the interconnection layer on a hard macro while influence of an interconnection pattern in the interconnection layer on the hard macro to the hard macro can be suppressed to the minimum.

Also, the permissible extending direction of the interconnection pattern can be restricted based on the arrangement restriction data.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a plan view showing a structure of a conventional semiconductor device;

FIG. 2 a plan view showing a structure of a conventional semiconductor device;

FIG. 3 an expanded view of a part of the plan view of FIG. 2;

FIG. 4 is a block diagram showing a configuration of a layout design supporting apparatus for a semiconductor device according to a first embodiment of the present invention;

FIGS. 5A and 5B are layout diagrams showing planar structures of the semiconductor device in the first embodiment;

FIG. 6 is a flowchart showing an operation of the layout design supporting apparatus in the first embodiment;

FIGS. 7A and 7B are layout diagrams showing planar structures of the semiconductor device in a second embodiment of the present invention;

FIG. 8 is a flowchart showing an operation of the layout design supporting apparatus in the second embodiment;

FIGS. 9A and 9B are layout diagrams showing planar structures of the semiconductor device in a third embodiment of the present invention; and

FIG. 10 is a flowchart showing an operation of the layout design supporting apparatus in the third embodiment.

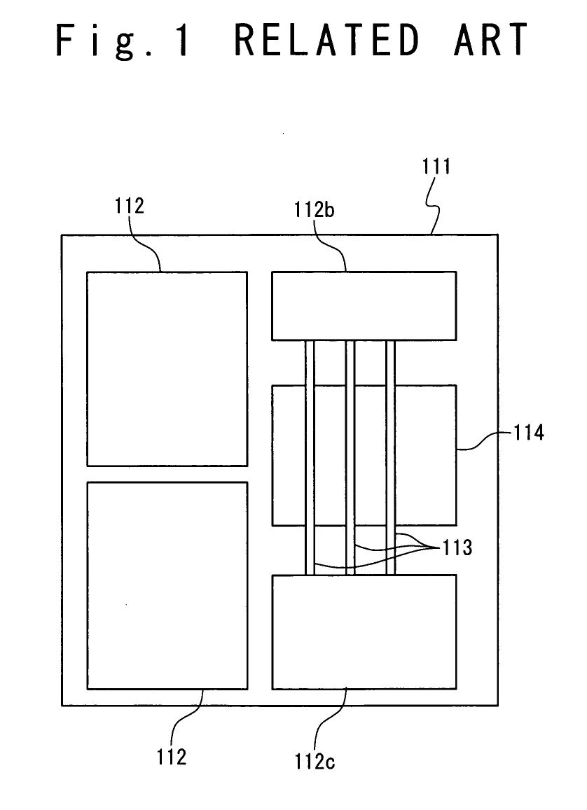

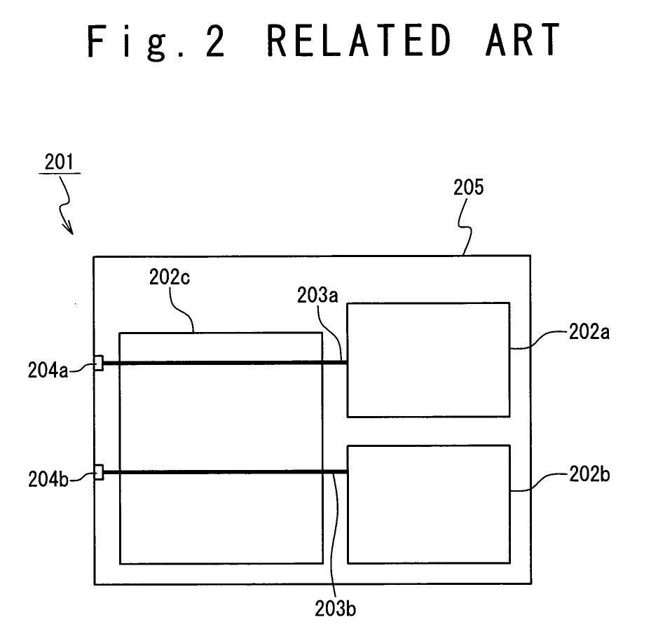

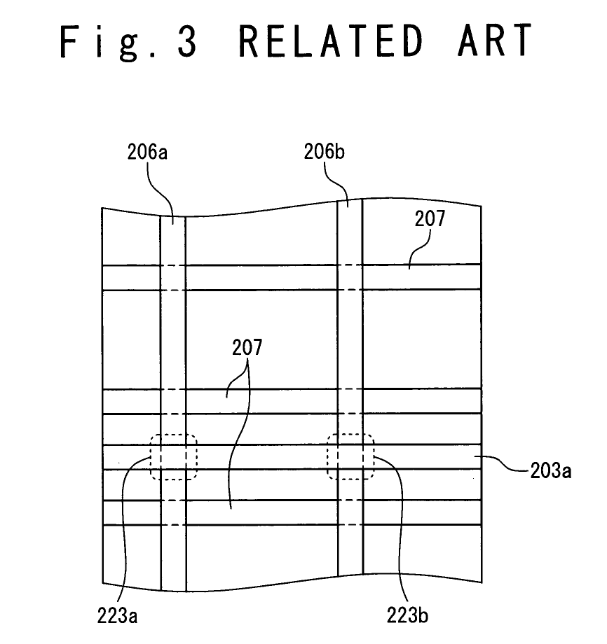

### DESCRIPTION OF THE PREFERRED EMBODIMENTS

Hereinafter, a layout design supporting apparatus for a semiconductor device according to the present invention with reference to the attached drawings. A hard macro in the present embodiment means a macro that the layout thereof has been hierarchically completed in units of functions. A hard macro data in the layout design includes data of input/output terminals and a data of size (or frame) of a chip. In a general layout design, several functional macros are handled as a hard macro to carry out the arrangement and interconnection.

### First Embodiment

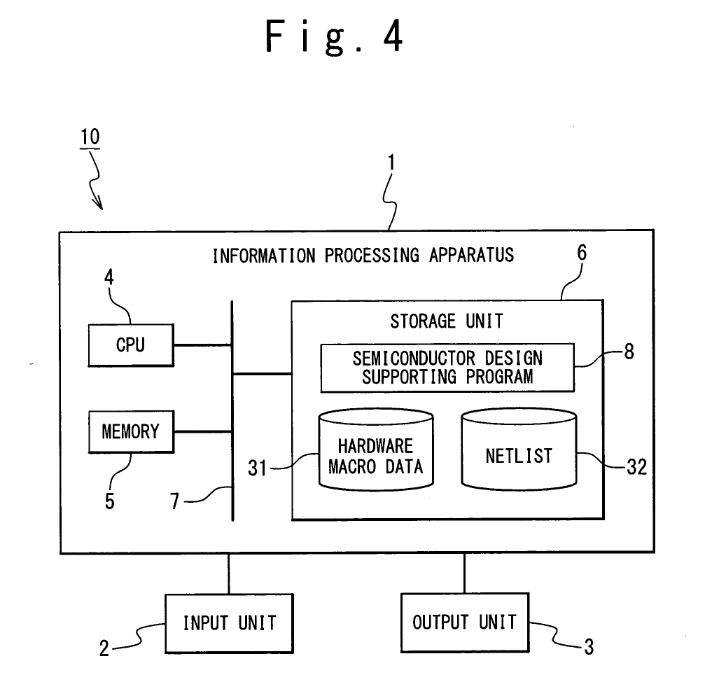

FIG. 4 is a block diagram showing a configuration of a layout design supporting apparatus 10 for a semiconductor device according to a first embodiment of the present invention. The layout design supporting apparatus 10 includes a data processing unit 1, an input unit 2 and an output unit 3.

The data processing unit 1 is a computer to execute data processes at a high speed in accordance with a procedure indicated by a program. The data processing unit 1 is provided with five basic functions which are an input function, a storage function, a calculation function, a control function and an output function. The input unit 2 is a man-machine interface to input a data into the data processing unit 1. The input unit 2 is exemplified as a keyboard, a mouse, a pen tablet and a touch panel. The output unit 3 is a man-machine interface to output the processing results of the data processing unit 1. The output unit 3 is exemplified as a display and a printer. The data processing unit 1 is provided with a CPU 4, a memory 5 and a large-capacity storage unit 6, which are connected to each other via a bus 7.

The CPU 4 is a central processing unit, and controls various kinds of units provided in the data processing unit 1 and processes data. The CPU 4 interprets, processes and calculates a data inputted from the input unit 2 and outputs the calculation result to the output unit 3.

The memory 5 is a semiconductor storage device such as DRAM and SRAM. A data is written in the memory 5 in response to an instruction from the CPU 4. The data is also read out from the memory 5 in response to an instruction from the CPU 4. It should be noted that the memory 5 in the present embodiment is not limited to DRAM or SRAM. It may be EEPROM and a flash memory.

The storage unit 6 is a storage unit such as an HDD. The storage unit 6 is provided with a function to hold data even if a power supply is turned off. It should be noted that the storage unit 6 of the present embodiment is not limited to the HDD. It may be EEPROM or flash memories. The storage unit 6 stores a semiconductor device design supporting program 8, hard macro data 31 and a netlist 32. The semiconductor device design supporting program 8 indicates a procedure of determining a layout of a semiconductor device to be designed. The semiconductor device design supporting program 8 is stored in a recording medium (not shown), is read out from the recording medium by the CPU 4 and is loaded in the memory 5. In the present embodiment, the CPU 4 executes calculations and data processes in accordance with the procedure indicated by the design supporting program 8. Thus, the data processing unit 1 functions as the layout design supporting apparatus 10 for a semiconductor device.

The hard macro data 31 includes data of hard macros for the semiconductor device to be designed. The hard macro includes data indicating connection between elements in the hard macro and data indicating layout of the hard macro on a chip. A layout of the elements within each hard macro has been completed prior to the layout thereof on the chip. The hard macro data 31 in the present embodiment has a multilayer interconnection structure from a first interconnection layer to an (m-1)^{th} interconnection layer as intra-macro interconnection layers, and an m^{th} interconnection layer is provided on the (m-1)^{th} interconnection layer as an intra-chip interconnection layer. More specifically, the hard macro data 31 includes a data indicating that an interconnection pattern is inhibited from being arranged in an area of the m^{th} interconnection layer (i.e. area restricting data) and an extension of the pattern into a specific direction is inhibited (i.e. direction restricting data). In the following embodiment, an arrangement restriction data includes a data of an interconnection layer, the area restricting data and the direction restricting data. The netlist 32 includes circuit connection data in a semiconductor device to be designed.

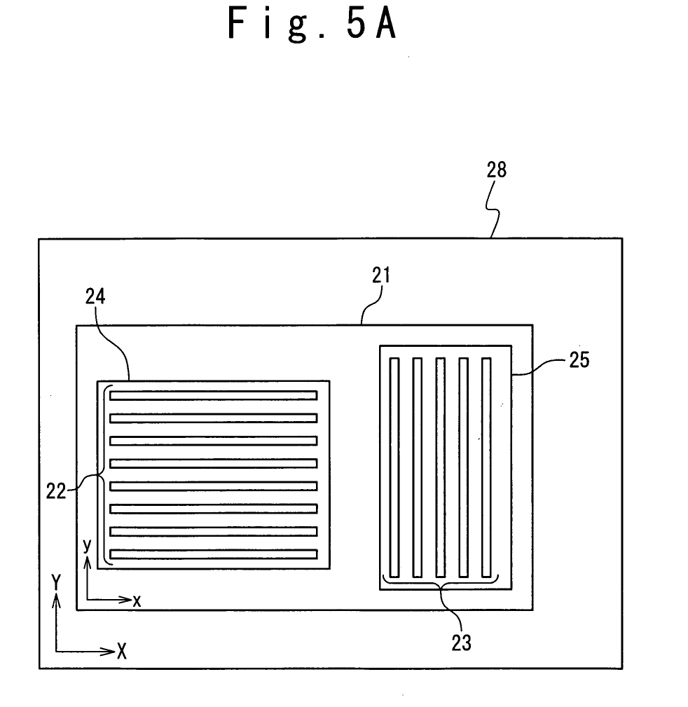

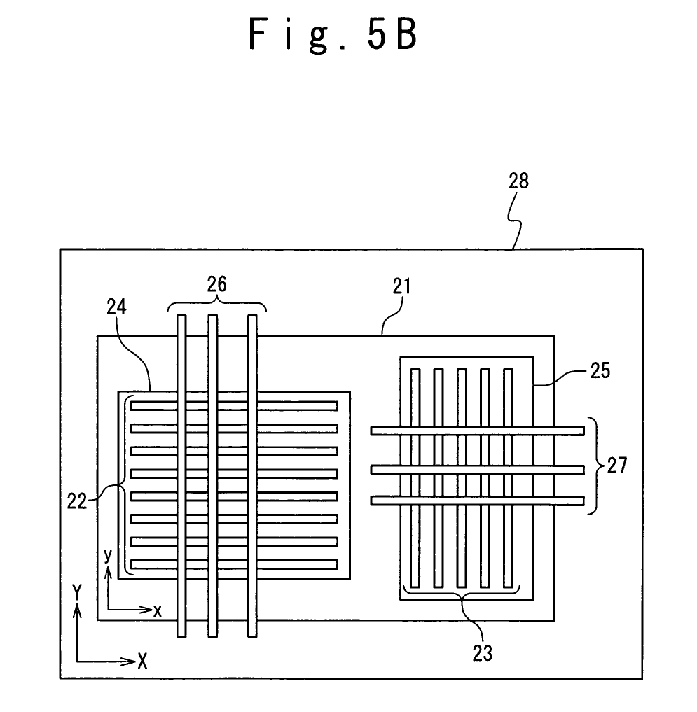

FIGS. 5A and 5B are layout diagrams showing a planar structure of the semiconductor device to be designed (to be referred to as a chip 28 hereinafter) in a layout designing method according to the present embodiment. The layout designing method in the present embodiment is applicable to the chip 28 which has a multilayer interconnection structure of the m layers (m is an integer larger than 1). The description of the following embodiment shows a case that the chip 28 has a multilayer interconnection structure with five interconnection layers, for easy understanding of the present invention. It is also assumed that a hard macro 21 arranged in the chip 28 uses the first interconnection layer to the fourth interconnection layer. Accordingly, in the present embodiment described below, intra-chip interconnection patterns are provided in the fifth interconnection layer on the hard macro 21. It should be noted that the chip 28 to be designed in the present embodiment is not limited to this structure. The layout designing method of the present embodiment is also applicable to a case that the chip 28 has the six interconnection layers and the hard macro 21 uses the first to fourth interconnection layers.

FIG. 5A is a layout diagram showing a planar structure of the chip 28 before the layout of intra-chip interconnection patterns are completed. As shown in FIG. 5A, the hard macro 21 includes an interconnection patterns 22 and an interconnection patterns 23 in the fourth interconnection layer. The interconnection patterns 22 in the fourth interconnection layer 22 are arranged to extend in the x direction. The interconnection patterns 23 in the fourth interconnection layer are arranged to extend in a y direction. Moreover, in the fifth interconnection layer on the fourth interconnection layer of the hard macro 21, the hard macro 21 is provided with arrangement restriction data to the fifth interconnection layer to restrict a first area 24 and a second area 25 in the fifth interconnection layer. The extension of the interconnection patterns into the x direction is restricted in the first area 24 in the fourth interconnection layer, and the extension of the interconnection patterns 23 into the y direction is restricted in the second area 25.

The above hard macro data 31 for the hard macro includes the arrangement restriction data that includes the interconnection patterns 22 extending into the x direction and the interconnection patterns 23 extending in the y direction, the area restricting data for the first area 24 and the second area 25, and the fifth interconnection layer. It is possible to change settings of the arrangement restriction data for each of the areas. For example, a setting may be performed to inhibit arrangement of intra-chip interconnection patterns in a specific area. Alternatively, the arrangement restriction data may be set for each of the interconnection patterns in the hard macro 21.

FIG. 5B is a layout diagram showing a planar structure of the chip 28 after the layout of intra-chip interconnection patterns is completed. The intra-chip interconnection patterns in the fifth interconnection layer on the hard macro 21 are arranged to extend in permissible directions, and arrangement to extend in the other directions is inhibited. As shown in FIG. 5B, and permissible direction in the first area 24 of the hard macro 21 is the y direction, and intra-chip interconnection patterns 26 are arranged to extend in the y direction. Similarly, a permissible direction in the second area 25 is the x direction, and intra-chip interconnection patterns 27 are arranged to extend in the x direction. As shown in FIG. 5B, in the chip 28, the interconnection patterns in the fourth layer of the hard macro 28 and the intra-chip interconnection patterns in the fifth interconnection layer are orthogonal to each other. Accordingly, a coupling capacitance therebetween is reduced to suppress crosstalk to a minimum.

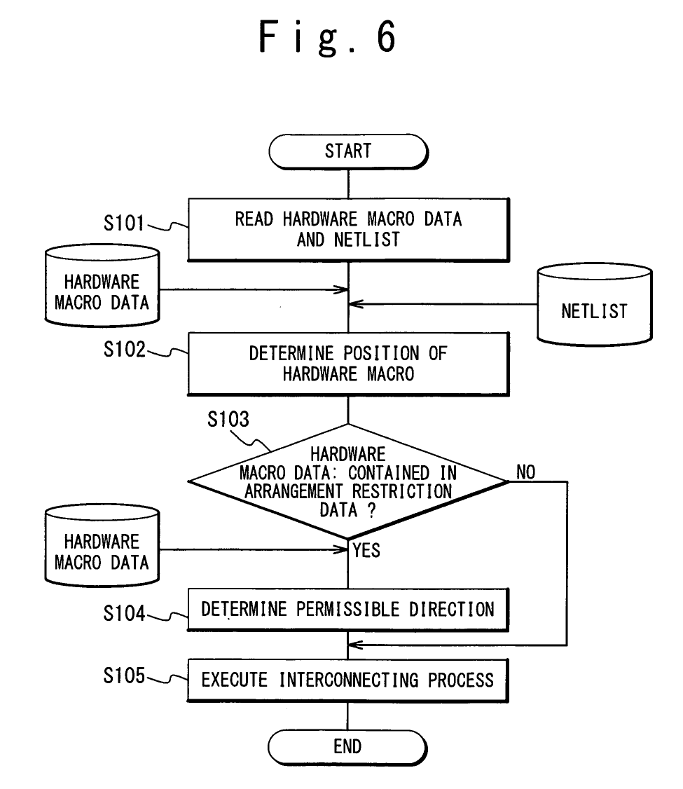

FIG. 6 is a flowchart showing an operation of the layout design supporting apparatus 10 for the semiconductor device in the present embodiment. With reference to FIG. 6, the operation of the layout design supporting apparatus 10 will be described using a case of designing the chip 28 having the hard macro 21 as an example. The following operation is realized by the data processing unit 1 in accordance with a procedure indicated by the layout design supporting program 8. As shown in FIGS. 5A and 5B, the chip 28 has a multilayer interconnection structure in which the first to fifth interconnection layers can be used for interconnection. The hard macro 21 uses the first to fourth interconnection layers.

Referring to FIG. 6, in the layout design supporting apparatus 10, the CPU 4 reads out the hard macro data 31 and the netlist 32 from the storage unit 6 at step S101. The hard macro data 31 includes the arrangement restriction data for the first area 24 and the second area 25 in the fifth interconnection layer on the hard macro 21. The hard macro data 31 further includes names, positions and shapes of input/output pins, and a macro size, in addition to the arrangement restriction data.

At step S102, the CPU 4 of the layout design supporting apparatus 10 performs a floor plan of the chip 28 based on the hard macro data 31 and the netlist 32 in accordance with the layout design supporting program 8 to determine an arrangement position of the hard macro 21 on the chip 28.

At step S103, the CPU 4 of the layout design supporting apparatus 10 determines whether or not the hard macro data 31 includes the arrangement restriction data. If the arrangement restriction data is included, the process advances to step S104. If the arrangement restriction data is not included, the process advances to step S105.

At the step S104, the CPU 4 of the layout design supporting apparatus 10 determines a permissible extension direction of interconnection patterns in the fifth interconnection layer on the hard macro 21 on the basis of the arrangement restriction data. More specifically, the CPU 4 recognizes the first area 24 and the second area 25 on the basis of the area restricting data, and determines the permissible extension directions based on the extension directions of the interconnection patterns in the first area 24 and the second area 25. Thereafter, the floor plan performed at the step S102 is used to recognize the direction of the interconnection patterns in the fourth interconnection layer of the hard macro. The CPU 4 determines the direction of the interconnection patterns in the fifth interconnection layer on the hard macro 21 from the permissible extension direction and the direction of the interconnection patterns. For example, FIGS. 5A and 5B show a case that the hard macro 21 is arranged without rotation on the chip 28. If the x-y coordinate system of the hard macro 21 is parallel to the X-Y coordinate system of the chip 28, the layout design supporting apparatus 10 determines the y-axis direction as a permissible extension direction in the first area 24, and determines an x-axis direction as a permissible extension direction in the second area 25. If the hard macro 21 is rotated and arranged on the chip 28 by an angle, the permissible extension direction in an area of the fifth interconnection layer on the hard macro 21 is determined in accordance with a rotation angle of the hard macro.

At step S105, after the determination of the permissible extension direction of interconnection patterns on the hard macro 21, arrangement of the interconnection patterns in the fifth interconnection layer above the hard macro 21 is performed based on the determination. The first to fifth interconnection layers can be used in an area other than an arrangement area of the hard macro. In case of the chip 28, it is determined that the interconnection patterns 26 in the first area 24 of the hard macro 21 are arranged in parallel to the y-axis direction, and the interconnection patterns 27 in the second area 25 thereof are arranged in parallel to the x-axis direction.

The arrangement restriction data of the hard macro data 31 may be changed when the permissible extension direction of the interconnection patterns in the fifth interconnection layer on the hard macro is determined at the step S104. That is, the arrangement restriction data may be added at the step of determining the arrangement of interconnection patterns in the fifth interconnection layer on the hard macro without any the arrangement restriction data at the time of floor planning at the step S102. The arrangement restriction data may be changed by storing the hard macro data with arrangement restriction data which is different from the data set at the time of floor planning. In this case, the hard macro data at the step S104 should be preferably used with priority. If the floor plan is performed by storing the hard macro data with the arrangement restriction data, temporary interconnection is performed in the floor plan and the arrangement position of the hard macro is determined by taking the arrangement of interconnection patterns on the hard macro into consideration.

Also, it is possible to determine the interconnection patterns, which can be arranged on the hard macro, without recognizing signal interconnection patterns in the hard macro by including the permissible extension direction in the arrangement restriction data for the hard macro. Therefore, steps can be omitted such as a step of extracting data on the interconnection layers and the shape of signal interconnection patterns in the hard macro, and a step of determining a permissible extension direction in the interconnection layer based on the extracted data, and a processing time can be shortened.

### Second Embodiment

Next, the layout design supporting apparatus for a semiconductor device according to a second embodiment of the present invention will be described with reference to drawings. According to the layout designing method in the second embodiment below, the arrangement restriction data is provided for the chip in the intra-chip interconnection for the interconnection layer instead of the hard macro data.

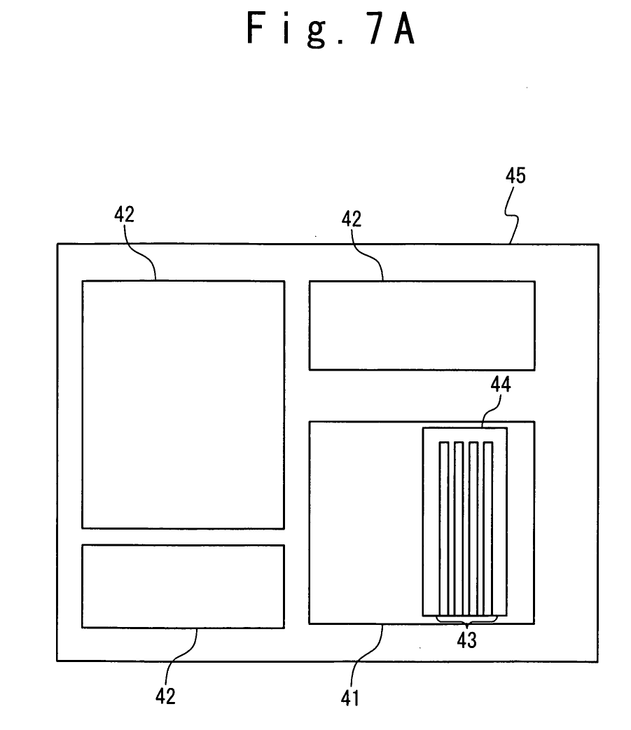

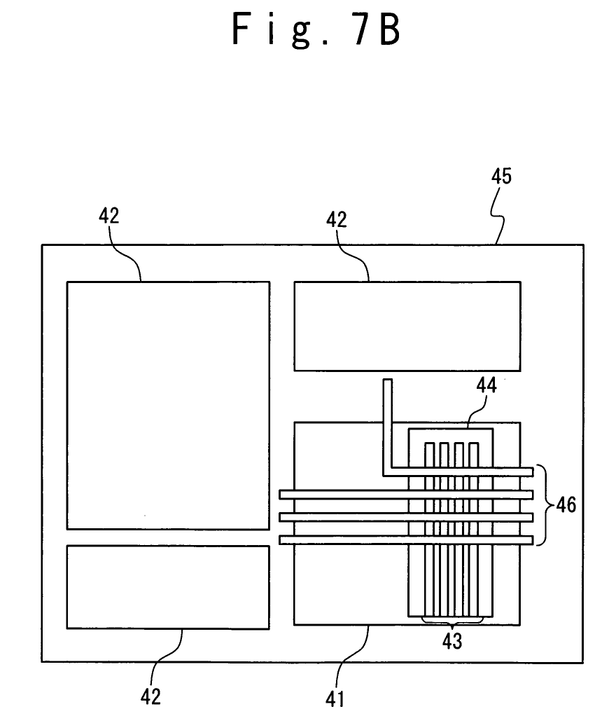

FIGS. 7A and 7B are layout diagrams showing a planar structure of the semiconductor device to be designed (to be referred to as a chip 45 hereinafter) according to the second embodiment. It should be noted that the chip 45 has an interconnection layer structure of five interconnection layers in the second embodiment. Each of a hard macro 41 and hard macros 42 arranged on the chip 45 is assumed to use the first to fourth interconnection layers. Accordingly, in the following description, the intra-chip interconnection is performed in the fifth interconnection layer.

FIG. 7A is a layout diagram showing the planar structure of the chip 45 before a layout of intra-chip interconnection is completed. As shown in FIG. 7A, the hard macro 41 includes interconnection patterns 43 in the fourth interconnection layer. The interconnection patterns 43 in an area 44 of the fourth interconnection layer are arranged to extend in the y-axis direction. When the fifth interconnection layer is arranged on or above the hard macro 41, the area 44 is designated to restrict interconnection patterns in the fifth interconnection layer. FIG. 7B is a layout diagram showing the planar structure of the chip 45 after the layout of intra-chip interconnection is completed. The interconnection patterns in the fifth interconnection layer are arranged to extend in the permissible extension direction, and extension in the other directions is inhibited. As shown in FIG. 7B, the permissible extension direction in the area 44 of the hard macro 41 is the x-axis direction, so that the intra-chip interconnection patterns 6 are arranged to extend in the x-axis direction.

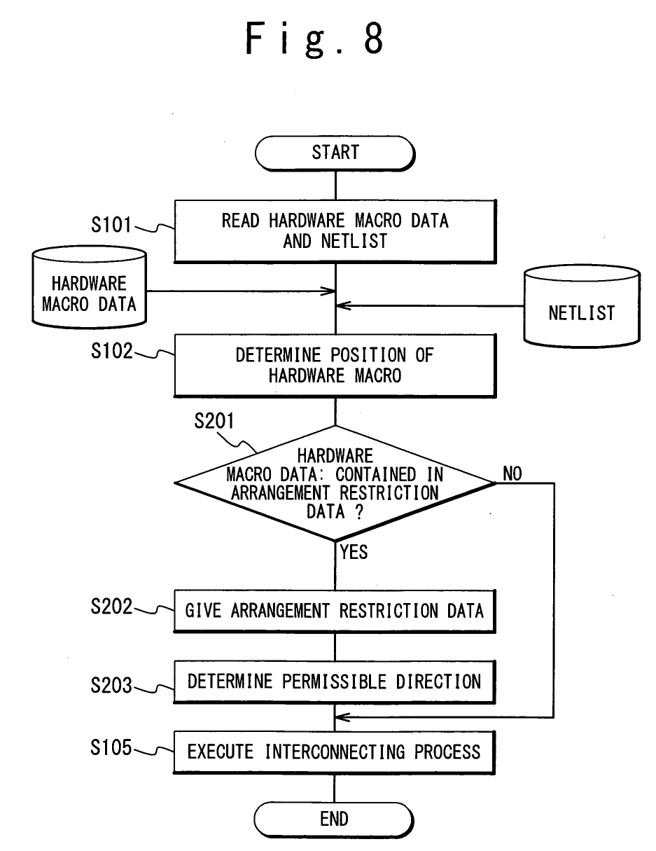

FIG. 8 is a flowchart showing an operation of the layout design supporting apparatus 10 according to the second embodiment of the present invention. The operation is realized by the data processing unit 1 in accordance with a procedure indicated by the layout design supporting program 8. The operation of the layout design supporting apparatus in the second embodiment includes steps of: providing the arrangement restriction data on or above the hard macro; and determining a permissible extension direction of the interconnection patterns in the fifth interconnection layer by recognizing the permissible extension direction (steps S201 to S203), which differs from that of the first embodiment. The arrangement restriction data includes an interconnection layer, an area and a permissible extension direction. The step of providing the arrangement restriction data is performed after performing a floor plan.

The steps S101 and S102 in FIG. 8 are similar to those of the first embodiment. At the step S101, the hard macro data 31 and the netlist 32 are read out from the storage unit 6 to perform the floor plan on a chip. The arrangement positions of the hard macros are determined at the following step S102.

At step S201, it is determined whether the arrangement restriction data to the fifth interconnection layer is necessary. If the arrangement restriction data is necessary, the process advances to step S202. If the arrangement restriction data is unnecessary, the process advances to step S105.

At the step S202, the arrangement restriction data to the fifth interconnection layer is supplied for the intra-chip interconnection from the input unit 2, for example. At this time, the arrangement restriction data includes a data indicating an area where the arrangement of the interconnection patterns is restricted. At step S203, the permissible extension direction of the interconnection patterns in the fifth interconnection layer on the hard macro 41 is determined from the area 44 and the permissible extension direction which are included in the supplied arrangement restriction data. At this time, the CPU 4 of the layout design supporting apparatus 10 provides a direction on the chip as the permissible extension direction without depending on a rotation angle of the hard macro 41. Based on the determination, the permissible extension direction in the fifth layer on or above the hard macro 31 is determined.

At step S105, the interconnection patterns 46 are arranged to extend in the permissible extension direction in the fifth interconnection layer based on the determination. The intra-chip interconnection patterns 46 are arranged to extend in the x-axis direction in the area 44 specified based on the arrangement restriction data.

The direction into which the interconnection patterns extend in the fifth interconnection layer on or above the hard macro 41 which uses the first to fourth interconnection layers is restricted based on the arrangement restriction data. Accordingly, it is possible to inhibit the intra-chip interconnection patterns from extending in parallel to interconnection patterns 43 in the fourth interconnection layer of the hard macro 41. Therefore, the crosstalk between the intra-chip interconnection patterns 46 in the fifth interconnection layer and the intra-macro interconnection patterns 43 in the fourth interconnection layer can be reduced. It is also possible to control arrangement of interconnection patterns in the intra-chip interconnection layer in subsequent steps even if the arrangement restriction data is not given to the hard macro data in advance.

### Third Embodiment

Next, the layout design supporting apparatus for a semiconductor device according to a third embodiment of the present invention will be described with reference to the drawings. According to the third embodiment, the arrangement restriction data is registered in association with not the hard macro but an area in the chip, to control the extension direction of intra-chip interconnection patterns. It is therefore possible to control the extension direction of interconnection patterns with respect to all the usable interconnection layers on the chip.

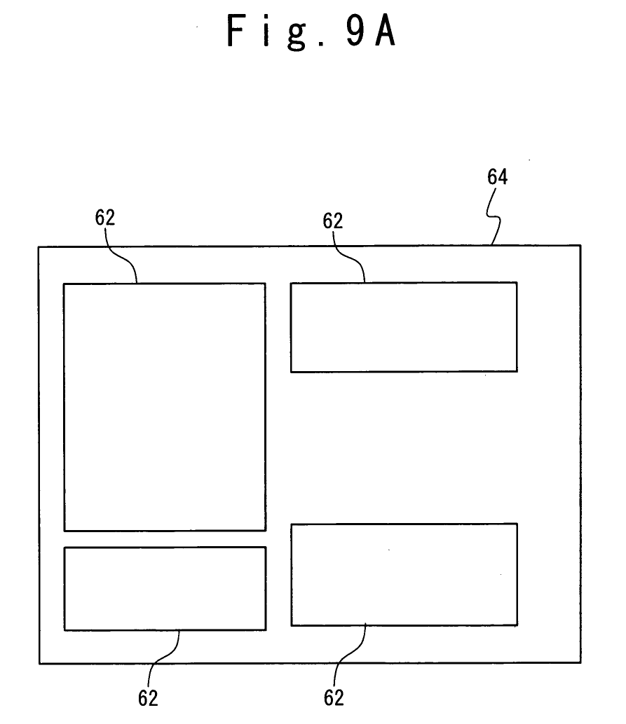

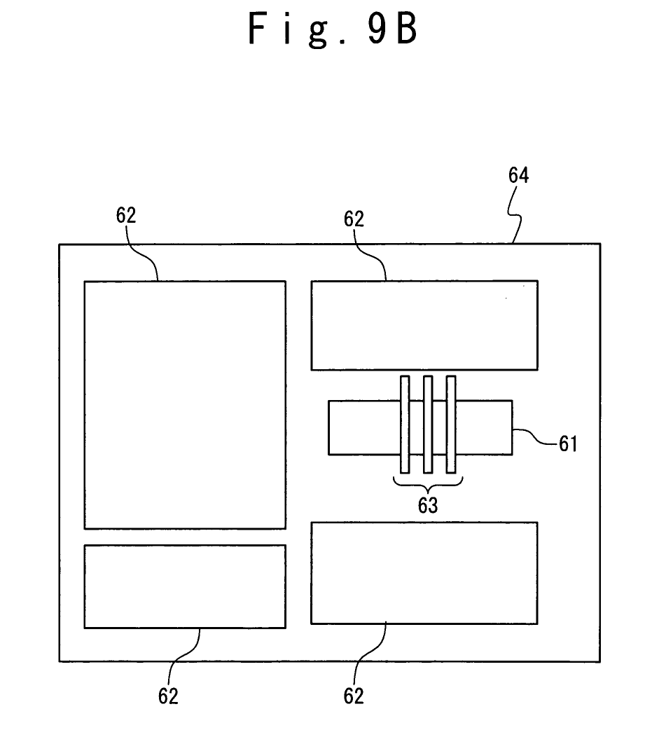

FIGS. 9A and 9B are layout diagrams showing a planar structure of the semiconductor device to be designed (to be referred to as a chip 64 hereinafter) according to the third embodiment. The chip 64 is allowed to use the first to fifth interconnection layers, and hard macros 62 are arranged on the chip to establish a hierarchical layout. It should be noted that the chip 64 has a multilayer layer structure of the first to fifth interconnection layers in the third embodiment. The hard macros 62 are also assumed to use the first to fourth interconnection layers. Accordingly, in the present embodiment, the intra-chip interconnection layer is the fifth interconnection layer on or above an area 61 on the chip 64.

FIG. 9A is a layout diagram showing the planar structure of the chip 64 before a layout of intra-chip interconnection is completed. As shown in FIG. 9A, the hard macros 62 are arranged on the chip 64. The chip is provided with the arrangement restriction data, which includes one interconnection layer, the restricted area 61 and a permissible extension direction of interconnection patterns, to control the extension direction of the interconnection patterns in the fifth interconnection layer. The arrangement restriction data can be set to each of the interconnection layers. FIG. 9B is a layout diagram showing the planar structure of the chip 64 after the layout of intra-chip interconnection is completed. As shown in FIG. 9B, the chip 64 has the restricted area 61 on the chip in which the extension direction of the interconnection patterns in the fifth interconnection layer is controlled. Intra-chip interconnection patterns 63 in the fifth interconnection layer are arranged on the basis of the arrangement restriction data. The arrangement restriction data includes a data specifying the restricted area 61, a data specifying the fifth interconnection layer, and a data indicating the permissible extension direction of the interconnection patterns.

The interconnection layer provided with the arrangement restriction data is restricted in the extension direction of the interconnection patterns in the restricted area 61. If the y-axis direction is permissible, the interconnection patterns are arranged to extend in the y-axis direction within the restricted area 61. It should be noted that in the layout design supporting apparatus 10 according to the third embodiment, the arrangement restriction data can be provided for each of the interconnection layers (e.g., the first to fifth interconnection layers) to an area used for interconnection in addition to the areas of the hard macros.

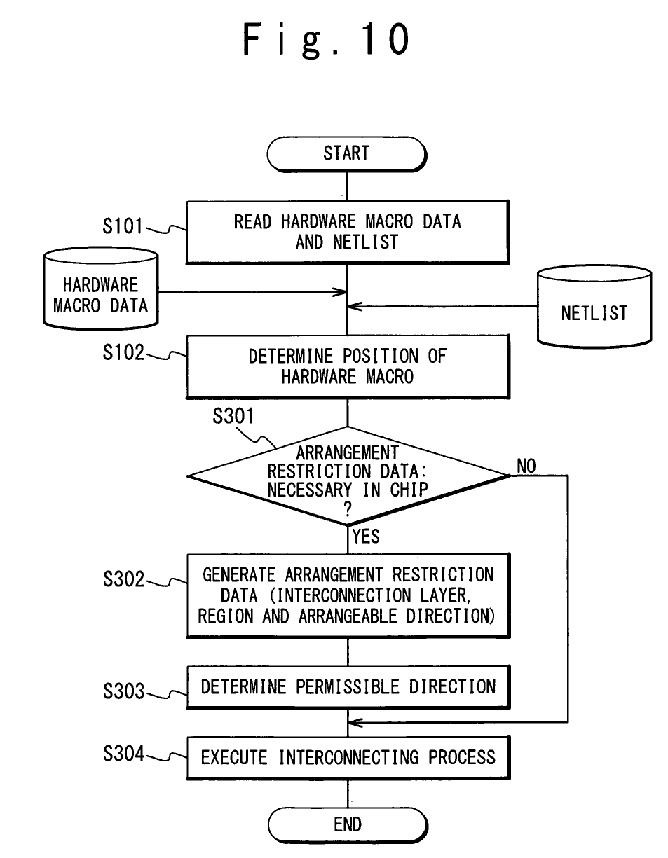

FIG. 10 is a flowchart showing an operation of the layout design supporting apparatus 10 in the third embodiment. Referring to FIG. 10, the operation of the layout design supporting apparatus 10 in the third embodiment will be described below. The operation is realized by the data processing unit 1 in accordance with a procedure indicated by the layout design supporting program 8. The process from the step S101 and the step S102 is similar to that of the first and second embodiments. The hard macro data 31 and the netlist 32 are read out at the step S101, and they are used at the step S102 to perform a floor plan of one chip and to determine arrangement positions of the hard macros.

At step S301, the CPU the layout design supporting apparatus 10 determines areas which require arrangement restriction of interconnection patterns in the first to fifth interconnection layers in the chip 64. If the arrangement restriction is necessary, the process advances to step S302. If the arrangement restriction is unnecessary, the process advances to step S304.

At the step S302, the arrangement restriction data is generated. At this time, by specifying one of the interconnection layers, specifying an area on the chip, and specifying a permissible extension direction of interconnection patterns, the arrangement restriction data is generated. The arrangement restriction data includes a data for specifying one of the interconnection layers, a data for specifying an area on the chip (e.g. the restricted area 61), and a permissible extension direction of interconnection patterns. At step S303, the permissible extension directions of the interconnection patterns are determined over the entire area on the chip. At step S304, the interconnection patterns are arranged according to the arrangement restriction data.

The extension direction of interconnection patterns can be controlled in the third embodiment. Therefore, the interconnection patterns which need consideration about the characteristics (e.g. interconnection patterns such as an analog interconnection pattern in which influence of noise from another interconnection pattern should be reduced) are inhibited from being arranged in parallel to the analog interconnection pattern.

It is also possible to control the arrangement of interconnection patterns in the intra-chip interconnection layer in subsequent steps without including the arrangement restriction data in the hard macro data in advance, so that the interconnection pattern arrangement on the chip can be controlled regardless of arrangement areas of the hard macros.

It should be noted that the above embodiments may be combined in case of no contradiction in the configuration and operation thereof.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A layout design method for a semiconductor device comprising a hard macro, comprising:
reading out a netlist data of the semiconductor device and a hard macro data from a storage section;
determining an arrangement position of said hard macro from the netlist data and the hard macro data;
determining an extension direction of an interconnection pattern in a specified area of a chip for the semiconductor device based on arrangement restriction data; and
arranging said interconnection pattern to extend in the determined extension direction in the specified area.

2. The method according to claim 1, further comprising:
storing said arrangement restriction data in said storage section as a part of said hard macro data in advance.

3. The method according to claim 1, further comprising:
supplying said arrangement restriction data.

4. The method according to claim 1, further comprising:
generating said arrangement restriction data.

5. The method according to claim 1, wherein said arrangement restriction data is provided for said hard macro.

6. The method according to claim 1, wherein said arrangement restriction data can be provided for each of interconnection layers of the chip.

7. The method according to claim 1, wherein said arrangement restriction data can be provided for an optional area of the chip.

8. A layout design supporting apparatus for a semiconductor device comprising a hard macro, comprising:
a storage section configured to store a netlist data of the semiconductor device and a hard macro data; and
a processing section configured to read out the netlist data of the semiconductor device and the hard macro data from said storage section, to determine an arrangement position of said hard macro from the netlist data and the hard macro data, to determining an extension direction of an interconnection pattern in a specified area of a chip for the semiconductor device based on arrangement restriction data, and to arrange said interconnection pattern to extend in the determined extension direction in the specified area.

9. The layout design supporting apparatus according to claim 8, wherein said hard macro data includes said arrangement restriction data.

10. The layout design supporting apparatus according to claim 8, further comprising:
an input unit configured to supply said arrangement restriction data to said processing section.

11. The layout design supporting apparatus according to claim 8, wherein said processing section generates said arrangement restriction data.

12. The layout design supporting apparatus according to claim 8, wherein said arrangement restriction data is provided for said hard macro.

13. The layout design supporting apparatus according to claim 8, wherein said arrangement restriction data can be provided for each of interconnection layers of the chip.

14. The layout design supporting apparatus according to claim 8, wherein said arrangement restriction data can be provided for an optional area of the chip.

15. A computer-readable recording medium in which code of a computer-readable program is recorded for a layout design method for a semiconductor device comprising a hard macro, said layout design method comprising:
reading out a netlist data of the semiconductor device and a hard macro data from a storage section;
determining an arrangement position of said hard macro from the netlist data and the hard macro data;
determining an extension direction of an interconnection pattern in a specified area of a chip for the semiconductor device based on arrangement restriction data; and
arranging said interconnection pattern to extend in the determined extension direction in the specified area.

16. The computer-readable recording medium according to claim 15, wherein said method further comprises:
storing said arrangement restriction data in said storage section as a part of said hard macro data in advance.

17. The computer-readable recording medium according to claim 15, wherein said method further comprises:
supplying said arrangement restriction data.

18. The computer-readable recording medium according to claim 15, wherein said method further comprises:
generating said arrangement restriction data.
